(19) United States
(12) Patent Application Publication
(10) Pub. No.: US 2014/0136397 A1
(43) Pub. Date: May 15, 2014

(54) METHOD AND SYSTEM FOR DETERMINING CREDIT RISK FROM DRIVING BEHAVIOR

(71) Applicant: GORDON*HOWARD ASSOCIATES, INC., Littleton, CO (US)

(72) Inventors: Gerald A. MORGAN, Littleton, CO (US); Stanley G. SCHWARZ, Indialantic, FL (US); Christopher M. MACHECA, Centennial, CO (US)

(73) Assignee: Gordon*Howard Associates, Inc., Littleton, CO (US)

(21) Appl. No.: 13/678,219

(22) Filed: Nov. 15, 2012

(51) Int. Cl. G06Q 40/02

(52) U.S. Cl. CPC G06Q 40/025
USPC 705/38

(57) ABSTRACT

Determining credit risk from driving behavior. At least some of the illustrative embodiments are methods including: determining an indication of credit risk related to a driving behavior of a driver in a vehicle, the determining by: detecting movement of the vehicle; collecting data related to the driving behavior of the driver; and creating the indication of credit risk for the driver.

### CROSS-REFERENCE TO RELATED APPLICATIONS

This application is a continuation-in-part of U.S. patent application Ser. No. 13/601,754 for “Activating Geo-Fence Boundaries and Collecting Location Data,” filed Aug. 31, 2012, which was a continuation of U.S. patent application Ser. No. 13/364,573 filed Feb. 2, 2012, which was a continuation of U.S. patent application Ser. No. 13/215,732 filed Aug. 23, 2011 (now U.S. Pat. No. 8,164,431), which was a continuation of U.S. patent application Ser. No. 12/333,904 filed Dec. 12, 2008 (now U.S. Pat. No. 8,018,329). All related applications are incorporated herein by reference as if reproduced in full below.

### BACKGROUND

A credit institution may look at a variety of information before agreeing to finance an applicant for a loan. While a credit institution may consider financial information, other information may help determine whether an applicant would be approved for a loan, and if approved, for determining credit parameters.

### BRIEF DESCRIPTION OF THE DRAWINGS

For a detailed description of exemplary embodiments, reference will now be made to the accompanying drawings in which:

FIG. 1 shows, in block diagram form, a system in accordance with at least some embodiments;

FIG. 2 shows, in block diagram form, a monitoring system in accordance with at least some embodiments;

FIG. 3 shows, in block diagram form, an identification module in accordance with at least some embodiments;

FIG. 4 shows, in block diagram form, an after-market system connected to a vehicle in accordance with at least some embodiments;

FIG. 5 shows, in block diagram form, a computer system in accordance with at least some embodiments; and

FIG. 6 shows, in block diagram form, a method in accordance with at least some embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

“Remote” shall mean one kilometer or more.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Various embodiments are directed to determining an indication of credit risk for an applicant based on the applicant's driving behaviors. In particular, a driver is identified and associated with a vehicle. In another embodiment, a vehicle is identified and associated with a drive. Regardless of the order in which the identifications take place, data related to the driver's operation of the vehicle is collected and an indication of credit risk is created for the driver based on the driver's driving behaviors. The indication of risk may be used to determine whether an applicant is approved for a loan, and if approved, may play a part in determining credit parameters associated with the loan.

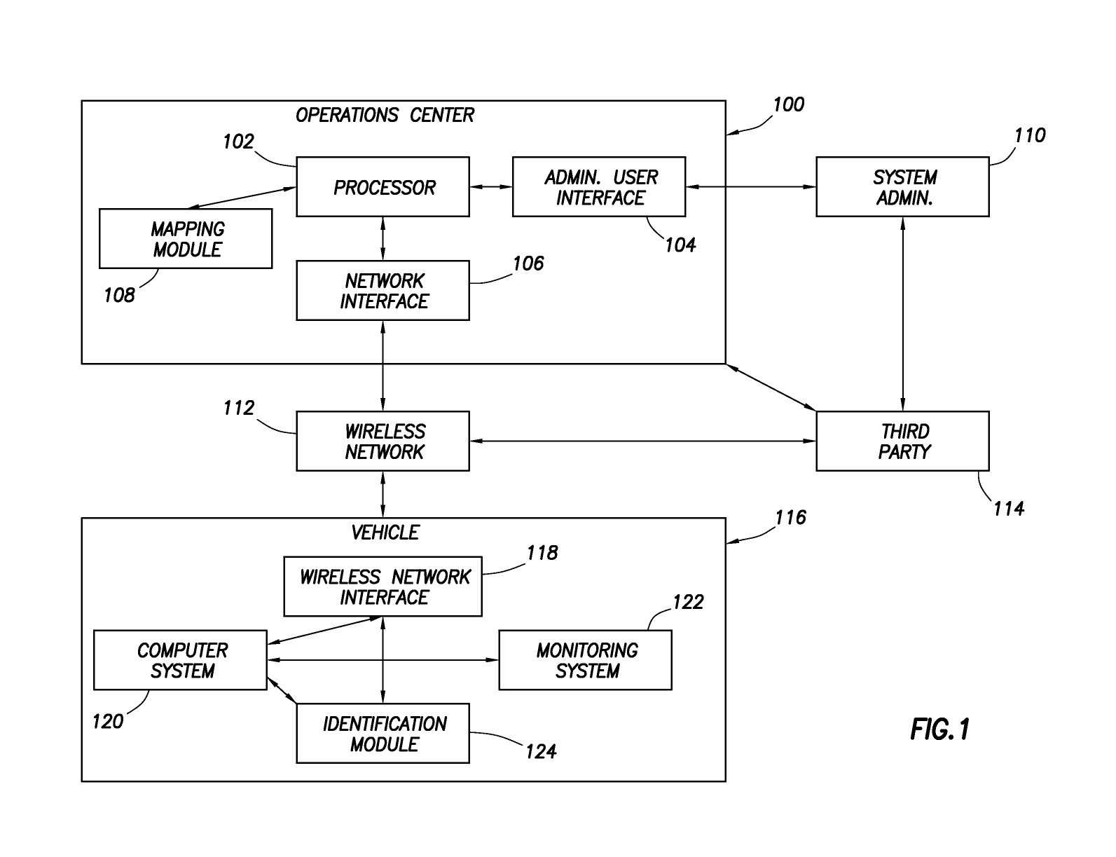

FIG. 1 shows, in block diagram form, a system in accordance with at least some embodiments. In particular, the system comprises an operations center 100 communicatively coupled to a vehicle 116 by way of a wireless network 112. The operations center 100 comprises a processor 102. In some embodiments, the processor 102 may be a stand-alone computer system, or the processor may comprise a plurality of computer systems communicatively coupled and performing the functions of the operations center, the functions discussed more thoroughly below. The processor 102 may couple to an administrative user interface 104. The administrative user interface may enable a system administrator 110 to control or configure the operation of the system.

The operations center 100 may further comprise a mapping module 108 coupled to the processor 102. In accordance with at least some embodiments, the mapping module 108 is a stand-alone computer system executing software to perform a mapping function associated with the location of the vehicle 116. In yet still other embodiments, the mapping module 108 may be a computer program or program package that operates or executes on the processor 102.

In order to communicate with the vehicle 116, the operations center 100 may further comprise a network interface 106 communicatively coupled to the processor 102. By way of the network interface 106, the processor 102, and any programs executing thereon, may communicate with vehicle 116, such as by wireless network 112. Wireless network 112 is illustrative of any suitable communications network, such as a cellular network, a pager network, or other mechanism for transmitting information between the operations center 100 and the vehicle 116.

In accordance with at least some embodiments, the operations center 100 is remotely located from the vehicle 116. In some cases, the operations center 100 and vehicle 116 may be located within the same city or state. In other cases, the operations center 100 may be many hundreds or thousands of miles from vehicle 116, and thus the illustrative wireless network 112 may span several types of communication networks.

Still referring to FIG. 1, the system further comprises a vehicle 116 communicatively coupled to operations center 100 by way of the illustrative wireless network 112. The vehicle 116 may comprise a computer system 120 communicatively coupled to a wireless network interface 118, a monitoring system 122, and an identification module 124. The wireless network interface 118 enables the computer system 120 to communicate with operations center 100 by way of a wireless transmission through the wireless network 112. The monitoring system 122 may assist the computer system 120 and/or the operations center 100 in collecting data related to the driving behavior of the driver. Identification module 124 may assist the computer system 120 and/or the operations center 100 in collecting data related to identifying which driver is operating the vehicle 116. Various techniques for monitoring the vehicle, as well as identifying the driver, will be discussed more thoroughly below.

In accordance with at least some embodiments, the operations center 100 may have the ability to send an indication of credit risk to a third party 114. The indication of credit risk may be transmitted using any suitable communications system, including web service electronic mail, short messaging service (SMS), instant messaging, automated telephone calls, and the like. Likewise, the vehicle 116, in some embodiments, may have the ability to directly send an indication of credit risk, such as by wireless network interface 118. However, in other cases, the indication of credit risk may be sent from the vehicle 116 by way of wireless network 112 to the operations center 100 before being sent to the third party 114.

The specification now turns to a high level description of detecting driving behaviors. In particular, driving behaviors may be detected, at least in part, by a device or devices in the monitoring system 122 coupled to the computer system 120. That is, either data gathered by the computer system 120 by way of the monitoring system 122 may determine driving behaviors, or data gathered by the monitoring system 122 and communicated to the operations center may determine the driving behaviors of a driver operating vehicle 116. Various example embodiments of determining driving behaviors will be discussed more thoroughly below.

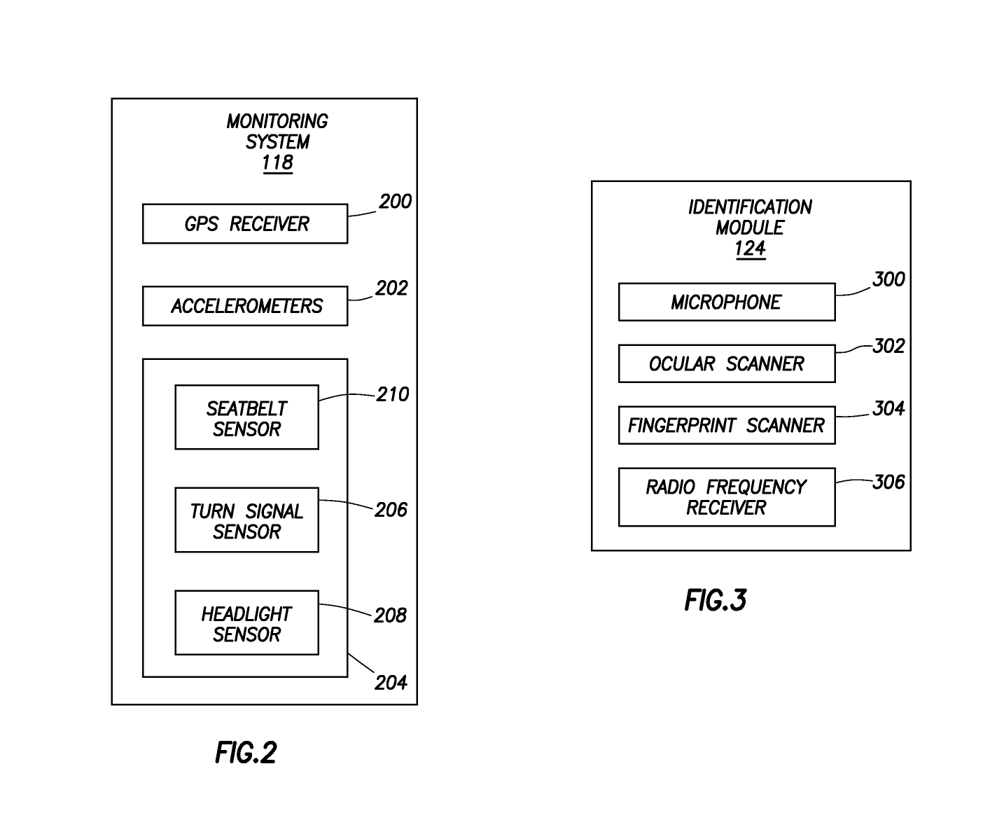

Turning now to FIG. 2, FIG. 2 shows, in block diagram form, monitoring system 120 in greater detail. In particular, in accordance with at least some embodiments, the monitoring system 120 may comprise a Global Positioning System (GPS) receiver 200. The GPS comprises a plurality of satellites broadcasting very precise timing signals. The GPS receiver 200, receiving a plurality of the timing signals, may determine not only the location of the GPS receiver 200 (and thus the vehicle 116), but may also establish navigation information, such as speed and direction of travel. In accordance with at least some embodiments, the navigation information derived from the GPS receiver 200 can be used to determine at least some driving behaviors. For example, in some embodiments, the tendency of the driver to exceed speed limits may be detected by monitoring the speed of the vehicle 116 as received by the GPS receiver 200. In another embodiment, location information received by GPS receiver 200 may aid in detecting whether the driver has a tendency to slam on his brakes by recognizing a sudden deceleration over a short period of time (e.g., coming to a complete stop from 60 miles per hour in two hundred feet or less). Slamming on the brakes may be indicative of coming to an unexpected stop when speeding, when tailgating, or when not paying attention to other drivers. In yet another embodiment, the vehicle may experience one or more sudden changes of directions in the z-plane (i.e., the horizontal plane), which may indicate a vehicle swerving in and out of traffic, or making quick, sudden lane changes.

In some cases, the computer system 120 communicating with GPS receiver 200 may make the determination that vehicle 116 is driving in a way that suggests a credit risk. In other cases, however, the computer system 120 may read the data from the GPS receiver 200, and send the data to the operations center 100 by the wireless network 112. Thus, in another embodiment, the operations center 100 determines the indication of credit risk based on data sent from the vehicle.

Still referring to FIG. 2, in addition to, or in place of, the GPS receiver 200, in accordance with at least some embodiments, the monitoring system 120 may comprise one or more accelerometers 202 communicatively coupled to the computer system 120. In some embodiments, a single accelerometer may be sufficient for determining the vehicle has applied the brakes, engaged the accelerator pedal, has changed lanes, and with what force and speed each action has occurred. In other embodiment's, the accelerometer 202 may comprise a three-axis accelerometer, such that acceleration in all three dimensions can be determined. While a three-axis accelerometer 202 cannot determine absolute position, data read from a three axis-accelerometer may be helpful in determining driving behaviors. Consider, for example, the situation of a driver slamming on his brakes to avoid hitting a car that has stopped in front of him. In some embodiments using an accelerometer, the deceleration rate of a vehicle exceeding some predetermined value may be indicative of the driver slamming on his brakes to avoid a collision or to avoid running a red light. Similarly, if the driver swerves to avoid a collision, or to change lanes swiftly, as may occur when a driver is weaving in and out of traffic, the three-axis accelerometer may be able to determine a rate of change of direction in the z-plane exceeding a predetermined value within a predetermined time. While at some levels the determination discussed with respect to the accelerometers are somewhat duplicative of the determinations that may be made using the GPS receiver 200, determinations using the accelerometers 202 may be made more quickly than the same determinations made using GPS receivers 200, and may also provide a different overall picture of a driver's driving habits.

Still referring to FIG. 2, monitoring system 120 may also comprise vehicle sensors 204. In one embodiment, vehicle sensor 204 may comprise a seat belt sensor 210 coupled to the computer system 120. The computer system 120 or the operations center 100 may collect data regarding whether or not the seat belts have been fastened. In another embodiment, vehicle sensors 204 may comprise a turn signal sensor 208 coupled to the computer system. The turn signal sensor, in addition to the GPS receiver and/or accelerometers, may indicate whether a driver is using turn signals before turning or changing lanes. In another embodiment, vehicle sensors 204 may comprise a headlight sensor 208 coupled to the computer system. Based on the time of day, the headlight sensor 208 may indicate whether a driver is driving in low light or dark conditions without the headlights being activated. The specification now turns to a high level description of identifying which driver is operating the vehicle for which data will be collected.

Turning now to FIG. 3, FIG. 3 shows, in block diagram form, an identification module 124. Identification module 124 is coupled to computer system 120 and wireless network interface 118, and may comprise a plurality of identification systems used to identify which driver is operating the vehicle. In particular, one vehicle may be driven by any number of drivers. For example, a family of four may have one vehicle which is driven by each of the four family members. In order to correctly assign an indication of credit risk to the correct driver, the identification module 124 identifies which driver is operating the vehicle. The method of identifying a specific driver will be discussed more thoroughly below.

In one embodiment, identification module 124 may comprise a radio frequency (RF) receiver 306. The RF receiver 306 may establish which driver is operating the vehicle by way of receiving an RF signal from a key fob assigned to the driver. A driver may be assigned a unique key fob which allows him to, among other possibilities, unlock the vehicle, configure the interior to his preset preferences, and identify him as the driver for whom operation of the vehicle will be monitored.

In yet another embodiment, identification module 124 may comprise a fingerprint scanner 304 operatively coupled to the computer system 120. The fingerprint scanner may establish which driver is operating the vehicle by way of receiving a scan of the driver's fingerprint. The scanned fingerprint is matched to fingerprint images stored in memory, and the driver is identified. In yet still another embodiment, identification module 124 may comprise a microphone 300 operatively coupled to the computer system 120. The microphone 300 may help establish which driver is operating the vehicle by way of voice recognition. In particular, the microphone receives audio signals representing the driver's voice and subsequently matches the signals to voice files stored in a computer system, such as within computer system 120 or processor 102. The driver is then identified and associated with the subsequent vehicle operation.

In yet still another embodiment, identification module 124 may comprise an ocular scanner 302 operatively coupled to the computer system 120. The ocular scanner 302 may help establish which driver is operating the vehicle by way of scanning the driver's eye. In one embodiment, the ocular scanner 302 may be an iris scanner, and in another embodiment, the ocular scanner 302 may be a retinal scanner, however the scanning is not limited to only iris and retinal scans. A driver may have his eye scanned, and then eye scan is then matched to ocular maps stored in memory, and the driver is associated with the subsequent vehicle operation.

In yet still another embodiment, the driver may be identified by way of the wireless network 122 receiving a signal from the driver's mobile device located within the vehicle. In particular, the wireless network 112 may communicate with the driver's mobile device (e.g., Bluetooth communications), to determine the mobile device is located within the vehicle, and thus associates the presence of the mobile device with the driver operating the vehicle.

While the above discussion provides a variety of ways in which the driver may be identified and subsequently linked to the operation of the vehicle, the ways in which the driver may be identified are not limited to the above examples.

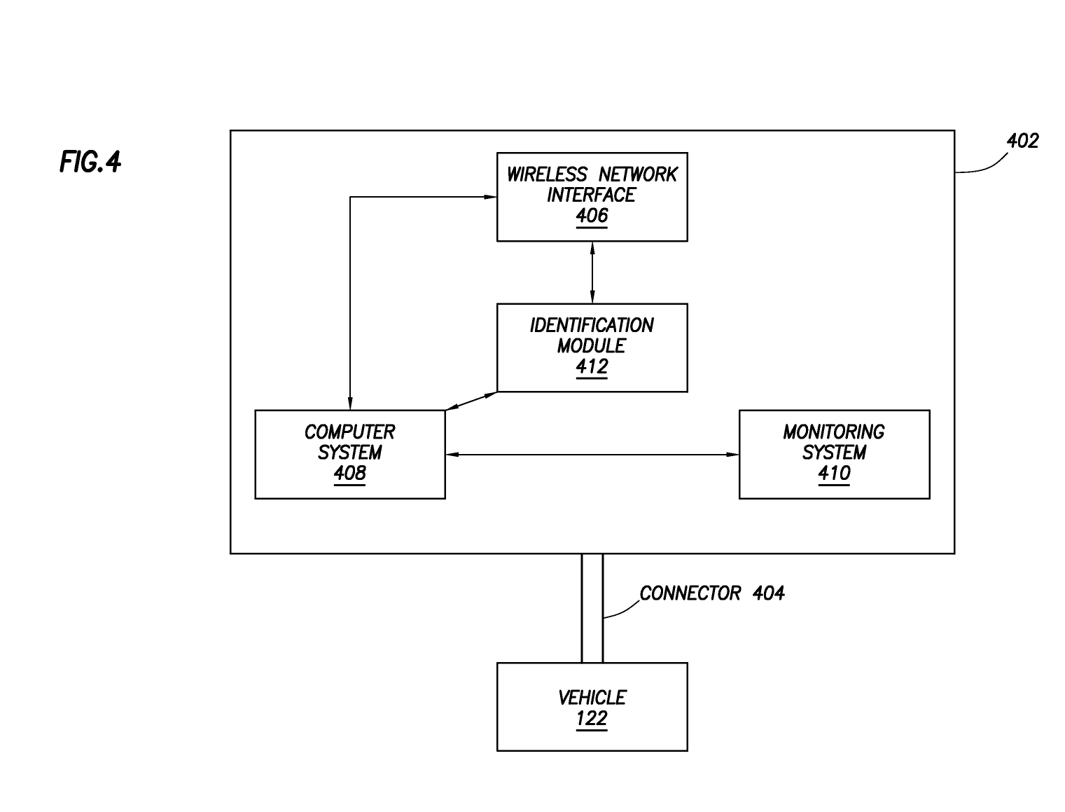

Referring now to FIG. 4, in some embodiments, the wireless network interface 118, computer system 120, monitoring system 122, and identification module 124 may be part of the vehicle 116 as purchased from the manufacturer or dealer. In other embodiments, however, the wireless network interface, computer system, monitoring system, and identification module may be part of a third-party after-market system 402. In particular, FIG. 4 shows, in block diagram form, after-market system 402 coupled to vehicle 116 by way of an electrical connector 404. In some embodiments, the after-market system 402 may be mechanically coupled to the inside of a vehicle 116, such as within the dashboard. In other embodiments, the after-market system 402 may be coupled at any suitable location, such as within the engine compartment, or in the trunk.

The specification now turns to determining an indication of credit risk based on the data collected related to the driver's driving behaviors. Once a driver has been identified, the system begins monitoring events indicative of driving behavior. As discussed previously, a plurality of driving behavior data may be collected including, but not limited to, the speed of travel; braking force applied; z-plane movement; seat belt usage; headlight usage; and turn signal usage. From the data collected, a computer system may analyze the data and using a set of algorithms, assign an indication of credit risk to the driver.

In one embodiment, the computer system 120 may create the indication of credit risk for the driver. In particular, the onboard device may collect data related to the operation of the vehicle and store the data within memory coupled to computer system 120. Computer system 120 may then analyze the data and create an indication of credit risk based on the data collected. In another embodiment, the operations center 100 may create the indication of credit risk for the driver. In particular, processor 102 may receive data collected from the onboard device coupled to vehicle 116 by way of wireless network 112. The operations center may then analyze the data received to create an indication of credit risk, before sending the indication to third party 114. In yet another embodiment, the driving behavior data collected by the onboard device coupled to vehicle 116 may be sent to the third party 114, either directly from the onboard device or from the operations center, by way of wireless network 112. In this embodiment, the third party may apply its own algorithm to the data to determine an indication of credit risk.

Regardless of how the indication of credit risk is created, the indication of credit risk may be represented as a number falling within a range of numbers. The numbers may be whole numbers, fractions, and/or decimal numbers, but for purposes of this discussion, an indication of credit risk is a whole number falling between 1 and 100 inclusively. In one embodiment, an indication of credit risk having a value of 100 may indicate the highest risk of driving behaviors. For example, a driver having a credit risk of 100 may frequently exceed the speed limits; may frequently slam on the brakes; may use seats belts infrequently or not at all; and/or may use turn signals infrequently or not at all. On the other hand, in another embodiment, an indication of credit risk having a value of 1 may indicate the lowest risk of driving behaviors. For example, a driver having a credit risk of 1 may frequently drive the speed limit; may rarely, if at all, slam on the brakes; always uses the seat belts; and/or always uses turn signals when turning or changing lanes. While the credit risk of a driver may be either 1 or 100 in this example, the indication of credit risk is likely to fall somewhere in between the two extremes.

Whether the indication of credit risk is calculated before sending to the credit institution, or whether the credit institution calculates the value itself, in one embodiment, the indication of credit risk may be used by a credit institution as an additional actuarial factor to consider when determining approval for financing or parameters associated with a loan For example, a driver scoring a higher risk value may indicate a lower level of overall responsibility, and thus a credit institution may decline to approve a loan because the risk of credit is too high. If the credit institution does elect to approve the loan, a higher risk value may result in a higher down payment; higher premium payment; a higher interest rate; and/or requesting that the driver obtain a guaranteed auto protection (GAP) contract. On the other hand, a lower risk value may indicate a higher level of responsibility and thus may result in a lower down payment; lower premium payment; and/or a lower interest rate.

The method of determining an indication of credit risk related to driving habits will now be discussed in more detail. FIG. 5 shows a flow diagram depicting an overall method of determining an indication of credit risk. The method starts (block 500), and moves to determining an indication of credit risk related to a driving behavior of a driver (block 502). The method of determining an indication of credit risk moves to detecting a movement of the vehicle (block 504), and collecting data related to the driving behavior of the driver (block 506). After collecting data, the method then moves to creating the indication of credit risk for the driver (block 508). Thereafter, the method ends (510).

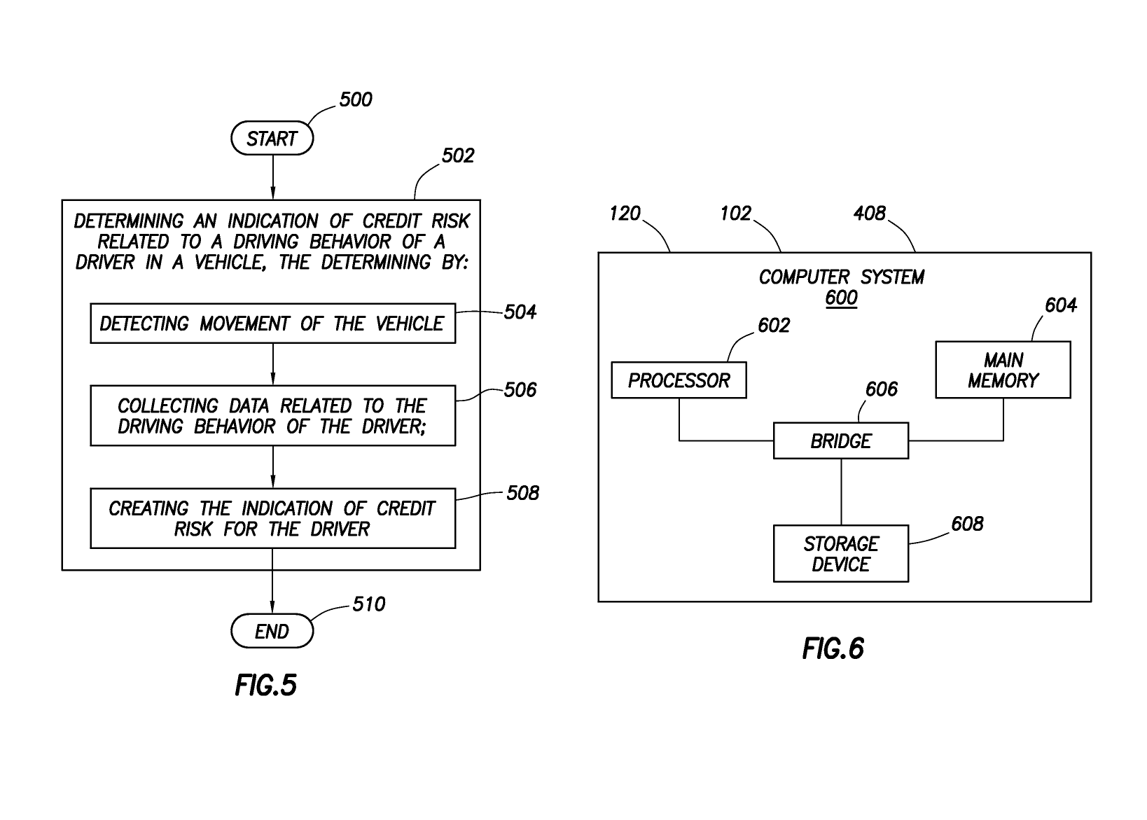

FIG. 6 shows a computer system 600 which is illustrative of a computer system upon which the various embodiments may be practiced. The computer system 600 may be illustrative of, for example, computer system 120 coupled to the vehicle 116. In another embodiment, computer system 600 may be illustrative of processor 102. In yet another embodiment, the computer system could be illustrative of computer system 408 coupled to third-party after-market system 402. The computer system 600 comprises a processor 602, and the processor couples to a main memory 604 by way of a bridge device 606 (e.g., a hard drive, solid state disk, memory stick, optical disc) by way of the bridge device 606. Programs executable by the processor 602 may be stored on the storage device 608, and accessed when needed by the processor 602. The program stored on the storage device 608 may comprise programs to implement the various embodiments of the present specification, such as determining driving habits of a driver. In some cases, the programs are copied from the storage device 608 to the main memory 604, and the programs are executed from the main memory 604. Thus, both the main memory 604 and storage device 608 shall be considered computer-readable storage mediums.

From the description provided herein, those skilled in the art are readily able to combine software created as described with appropriate general-purpose or special-purpose computer hardware to create a computer system and/or computer sub-components in accordance with the various embodiments, to create a computer system and/or computer sub-components for carrying out the methods of the various embodiments and/or to create a non-transitory computer-readable medium (i.e., not a carrier wave) that stores a software program to implement the method aspects of the various embodiments.

References to “one embodiment,” “an embodiment,” “some embodiment,” “various embodiments,” or the like indicate that a particular element or characteristic is included in at least one embodiment of the invention. Although the phrases may appear in various places, the phrases do not necessarily refer to the same embodiment.

The above discussion is meant to be illustrative of the principals and various embodiments of the present invention. Numerous variations and modifications will become apparent to those skilled in the art once the above disclosure is fully appreciated. For example, while the various embodiments have been described in terms of driver behaviors impacting credit parameters, this context, however, shall not be read as a limitation as to the scope of one or more of the embodiments described—the same techniques may be used for other embodiments. It is intended that the following claims be interpreted to embrace all such variations and modifications.

1-2. (canceled)

3. A method comprising:
determining an indication of credit risk related to a driving behavior of a driver in a vehicle, the determining by:
identifying the driver by an onboard device, the identifying by way of at least one selected from the group comprising: a radio-frequency signal from an electronic key fob assigned to the driver; and a wireless signal from a mobile device;
detecting, by the onboard device, movement of the vehicle;
collecting data related to the driving behavior the driver; and
creating the indication of credit risk for the driver.

4. The method of claim 3 further comprising sending the indication of credit risk to a third party.

5. The method of claim 4 wherein sending the indication of credit risk further comprises sending to a credit institution.

6. The method of claim 3 wherein collecting data further comprises collecting at least one selected from the group comprising: location of the vehicle; speed of the vehicle; acceleration of the vehicle; deceleration of the vehicle; turn signal usage of the vehicle; and seat belt usage of the vehicle.

7. The method of claim 3 wherein detecting the movement of the vehicle further comprises detecting the movement based on Global Positioning System monitoring of the vehicle.

8. The method of claim 3 wherein detecting the movement of the vehicle further comprises detecting by a three-axis accelerometer associated with the vehicle.

9-10. (canceled)

11. A system comprising:
an onboard device comprising:
a processor;
a global positioning system receiver coupled to the processor;
a wireless interface coupled to the processor;
a radio frequency receiver coupled to the processor;
a memory coupled to the processor, the memory storing a program that, when executed by the processor, causes the processor to:
identify a driver in a vehicle, by way of at least one selected from the group consisting of: a radio-frequency signal received from an electronic key fob assigned to the driver; and a wireless signal received from a mobile device located within the vehicle;
detect a movement of the vehicle related to a driving behavior of the driver;
collect data related to the driving behavior of the driver; and
send the data to a remote operations center.

12-14. (canceled)

15. The system of claim 11 wherein when the processor collects, the program further causes the processor to collect data related to at least one selected from the group comprising: location of the vehicle; speed of the vehicle; acceleration of the vehicle; deceleration of the vehicle; turn signal usage of the vehicle; and seat belt usage of the vehicle.

16-17. (canceled)

18. A system comprising:
a processor;
a wireless interface coupled to the processor;
a memory coupled to the processor, the memory storing a program that, when executed by the processor, causes the processor to:
receive an identity of a driver in a vehicle by way of a wireless transmission, wherein the identity of the driver is determined by way of at least one selected from the group comprising: a radio-frequency signal from an electronic key fob assigned to the driver; and a wireless signal received from a mobile device located within the vehicle;
receive data related to a driving behavior of the driver by way of a wireless transmission; and
create an indication of credit risk for the driver.

19. The system of claim 18 wherein the program further causes the processor to send the indication of credit risk to a third party.

20. The system of claim 18 wherein when the processor sends the indication of credit risk, the program further causes the processor to send to a credit institution.

21. A method comprising:
determining an indication of credit risk related to a driving behavior of a driver in a vehicle, the determining by:
identifying the driver in the vehicle by an onboard device;
detecting movement of the vehicle;
collecting data related to the driving behavior the driver; and
creating, by the onboard device, the indication of credit risk for the driver.

22. A system comprising:
an onboard device comprising:
a processor;
a global positioning system receiver coupled to the processor;
a wireless interface coupled to the processor;
an accelerometer coupled to the processor;
a memory coupled to the processor, the memory storing a program that, when executed by the processor, causes the processor to:
identify a driver in a vehicle;
detect a movement of the vehicle related to a driving behavior of the driver based on movement detected by the accelerometer;
collect data related to the driving behavior of the driver; and
send the data to a remote operations center.

23. The system of claim 22 further comprising wherein when the processor detects, the program further causes the processor to detect based on Global Positioning System monitoring of the vehicle.

24. The system of claim 22 wherein the accelerometer is a three-axis accelerometer.

25. A system comprising:
an onboard device comprising:
a processor;
a wireless interface coupled to the processor;
a memory coupled to the processor, the memory storing a program that, when executed by the processor, causes the processor to:
identify a driver in a vehicle;
detect a movement of the vehicle related to a driving behavior of the driver;
collect data related to the driving behavior of the driver;
calculate a value of credit risk for the driver; and
send the value to a third party.

26. The system of claim 25 further comprising:
a global positing system receiver coupled to the processor;
wherein when the processor calculates the value, the program further causes the processor to communicate with the global positioning system receiver to determine the driver is driving in a way that indicates a credit risk.
